(19) United States
(12) Patent Application Publication
(10) Pub. No.: US 2015/0324841 A1
(43) Pub. Date: Nov. 12, 2015

(54) CONTEXT-SENSITIVE ADVERTISING FOR INTERNET PROTOCOL TELEVISION

(71) Applicant: Telefonaktiebolaget L M Ericsson (publ), Stockholm (SE)

(72) Inventor: Bradley Robert PETTIT, Los Gatos, CA (US)

(73) Assignee: Telefonaktiebolaget L M Ericsson (publ), Stockholm (SE)

(21) Appl. No.: 14/275,647

(22) Filed: May 12, 2014

(51) Int. Cl. G06Q 30/02

(52) U.S. Cl. CPC G06Q 30/0251; G06Q 30/0277

(57) ABSTRACT

A method in a server device for context-sensitive advertising is described. The method includes receiving a first request for an advertisement from a first client device. The method further includes determining, based upon the first request, an account associated with a second client device. The method further includes transmitting a message to the first client device to cause the first request for the advertisement to be fulfilled with a targeted advertisement that is selected based on a media program played by the second client device.

### FIELD

Embodiments of the invention relate to the field of Internet Protocol television; and more specifically, to context-sensitive advertising for Internet Protocol television.

### BACKGROUND

A developing method of television content distribution is Internet Protocol television (IPTV). Instead of using traditional television distribution mechanisms like wireless over-the-air broadcasting, analog coaxial television channel signals, and aerial satellite signals, an IPTV system broadcasts multimedia via Internet Protocol (IP) packets over IP networks, such as the Internet. IPTV may leverage new communications mediums, such as fiber optic lines, or more traditional communications mediums, such as telephone or coaxial lines, in order to distribute the IP packets to a user. IPTV also typically includes more features compared to traditional TV systems. These new features may include the ability to watch time-shifted broadcasts and access video on demand. Furthermore, IPTV may also allow the IPTV provider to gather additional information regarding the user because unlike a traditional TV broadcast system an IPTV device at the user's premises is able to send data back to the IPTV provider's systems.

In additional to watching television, present-day consumers have many options on which they can use their recreational time, and may utilize many of these options at the same time. For example, a user may be using their laptop or mobile device while watching television. Users may also focus on their laptop or mobile device when the television broadcast is playing advertisements. Thus, a challenge for a television provider is to keep the user engaged in the advertising during a media program so that advertisement sales to advertisers remain steady.

### SUMMARY

According to some embodiments, a method in a server device for context-sensitive advertising is described. The method includes receiving a first request for an advertisement from a first client device. The method further includes determining, based upon the first request, an account associated with a second client device. The method further includes transmitting a message to the first client device to cause the first request for the advertisement to be fulfilled with a targeted advertisement that is selected based on a media program played by the second client device.

According to some embodiments, transmitting the message to the first client device to cause the first request for the advertisement to be fulfilled includes transmitting a redirect message to the first client device to cause the first client device to transmit a second request for the advertisement. According to some embodiments, the second request for the advertisement is transmitted to the second client device.

According to some embodiments, prior to the transmitting the message to the first client device, the method further includes transmitting a third request to a residential gateway for a local network address of the second client device, wherein the local network address is not a globally routable address, and receiving the local network address of the second client device from the residential gateway.

According to some embodiments, the client device, responsive to a response message received from the second client device including an indicator of the media program played by the second client device, transmits a third request to an advertisement server for the advertisement that includes the indicator of the media program played by the second client device.

According to some embodiments, the redirect message is transmitted to an advertisement server, and wherein the redirect message includes an indicator of the media program played by the second client device.

According to some embodiments, the server device comprises the advertisement server.

According to some embodiments, transmitting the message to the first client device to fulfill the first request for the advertisement includes transmitting the targeted advertisement to the first client device.

Thus, embodiments of the invention allow for context-based advertising based on a currently playing media program. In some embodiments, the context-based advertising is performed in an IPTV network.

### BRIEF DESCRIPTION OF THE DRAWINGS

The invention may best be understood by referring to the following description and accompanying drawings that are used to illustrate embodiments of the invention. In the drawings:

FIG. 1 illustrates a system for context-sensitive advertising according to an embodiment of the invention.

FIG. 2 is a first network transaction diagram illustrating an exemplary set of operations for context-sensitive advertising.

FIG. 3 is a second network transaction diagram illustrating an exemplary set of operations for context-sensitive advertising.

FIG. 4 is a third network transaction diagram illustrating an exemplary set of operations for context-sensitive advertising.

FIG. 5 is a fourth network transaction diagram illustrating an exemplary set of operations for context-sensitive advertising.

FIG. 6 is a fifth network transaction diagram illustrating an exemplary set of operations for context-sensitive advertising.

FIG. 7 is a flow diagram illustrating a method in a server device for context-sensitive advertising according to an embodiment of the invention.

FIG. 8 illustrates a block diagram for an exemplary data processing system that may be used in some embodiments.

### DESCRIPTION OF EMBODIMENTS

The following description describes methods and apparatus for context-sensitive advertising for Internet Protocol Television. In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with an embodiment whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

A developing method of television content distribution is Internet Protocol television (IPTV). Instead of using traditional television distribution mechanisms like wireless over-the-air broadcasting, analog coaxial television channel signals, and aerial satellite signals, an IPTV system broadcasts multimedia via Internet Protocol (IP) packets over IP networks, such as the Internet. IPTV may leverage new communications mediums, such as fiber optic lines, or more traditional communications mediums, such as telephone or coaxial lines, in order to distribute the IP packets to a user. IPTV also typically includes more features compared to traditional TV systems. These new features may include the ability to watch time-shifted broadcasts and access video on demand. Furthermore, IPTV may also allow the IPTV provider to gather additional information regarding the user because unlike a traditional TV broadcast system an IPTV device at the user's premises is able to send data back to the IPTV provider's systems.

In addition to advances in television distribution, today's methods of content consumption have changed as well. Consumers have more access to different types of connected devices, such as laptops, tablets, mobile phones, e-readers, smart wearable devices, etc. Typically, a user may be using his or her connected device while watching television. For example, a user may be looking up information for the currently watched program, or might be browsing various websites while an advertisement is playing on the television. In these cases, there is an opportunity to show advertisements to the user via the connected device that the user is using.

According to embodiments of the invention, a server device receives a request for an advertisement from a user's connected client device and determines that a second device has an associated account. In some embodiments, this second device is a set top box or smart television in an Internet Protocol television system. In some embodiments, this second device may be on the same LAN as the user's connected device, or within the same room as the user. The server device then transmits a message to the user's connected device to cause it to request a particular advertisement which is targeted based on the media program being played by another client device. In some embodiments, user's connected device is able to send a request to the second device to discover the currently playing program so that the user's connected device may forward an identifier of the currently playing program to a server to request the advertisement that is selected based on the currently playing program.

Thus, in some embodiments, the server device operates so that a user views an advertisement on his or her connected device that is selected and/or customized based upon the current program that the user is watching. For example, a user may have the television turned on to a popular show about a high school chemistry teacher turned drug dealer, but decides not to watch the television during commercial breaks and instead decides to browse a social network website during that time on the user's connected device. The advertisements on the social network website may then be selected based on the currently playing program, and may advertise merchandise from the program, or may show advertisements that are known to appeal to those demographics that watch the show.

Although the user is viewing his or her device instead of watching the television, this system allows a television service provider to continue to provide targeted advertisements to the user. This is in contrast to current systems, where the user sees advertisements his or her device that are unrelated to the television program. One potential advantage of such a targeted advertising program is that users continue to see relevant and targeted advertisements even though the user is skipping the advertisements on the television. This may increase or maintain the effectiveness of commercials being played on the television or sold by the television network. Another potential advantage is that the system provides an additional revenue source, as a user may be simultaneously using his or her device while watching the program, and causing targeted advertisements to be displayed on the device will increase the likelihood that a user will engaged with that advertisement.

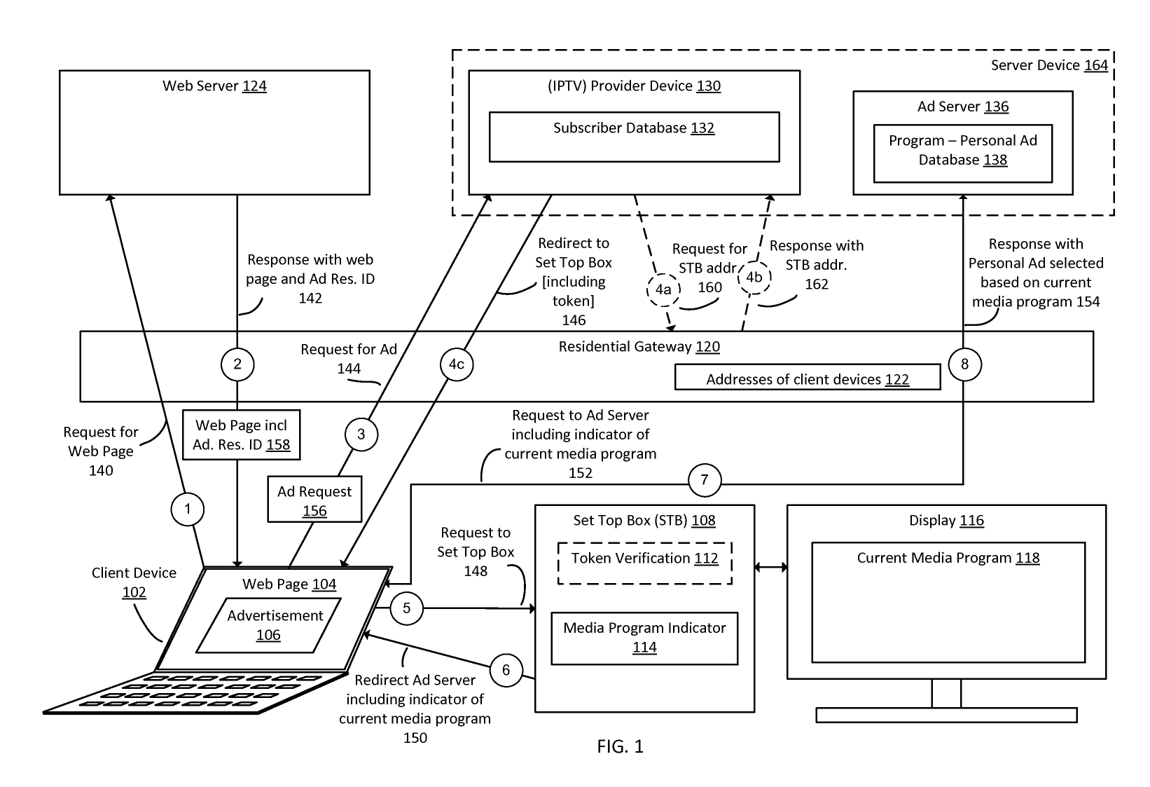

FIG. 1 illustrates a system for context-sensitive advertising according to an embodiment of the invention. In FIG. 1, the circled numbers are used to denote each communication between the different devices in the system. In some embodiments, the order of operations follows the order of the circled numbers.

The system includes a client device 102 that includes a display or connects to a display and can connect to the network. The client device 102 may be a laptop computer, desktop computer, mobile phone, tablet device, e-reader device, head mounted display, wearable device, internet connected television, set top box, etc. In some embodiments, client device 102 accesses a web page 104 that includes an advertisement 106. In some embodiments, client device displays advertisement 106 through another application, such as an e-reader application, a mobile application, etc. Advertisement 106 may be text, a static image, an audio clip, a video clip, or other media element.

At circled number 1, the client device sends a request for web page 140 from web server 124. At circled number 2, web server 124 sends a response to client device 102 with a web page including an ad resource ID 142. The ad resource ID 158 includes a reference to the address where the client device 102 may request the advertisement. The ad resource ID 158 may include a Uniform Resource Locator (URL), a URL with a query string, an IP address, or other means of referencing the location of the advertisement on a network.

In some embodiments, client device 102 includes an application (e.g., a mobile application), and the web server 124 is a server for content for the application. In these embodiments, the client device 102 requests content from the server 124 for the application, and the server 124 responds with the content including an ad resource ID 158.

In some embodiments, server 124 is a server that hosts an advertisement network. This network provides advertisements to websites or applications that are linked to the advertisement network. In these embodiments, client device 102 requests an advertisement from the server 124. The server 124 then responds with an ad resource ID 158. For example, such a system could occur where the client device 102 is a mobile device, and is running an application that is linked to an advertisement network served by server 124. When the application wishes to display an ad, it will cause the client device 102 to request an advertisement from server 124, and the server 124 may respond with ad resource ID 158.

In some embodiments, client device 102 is located behind a residential gateway (RG) 120. The residential gateway may act as a router between devices in a local area network, such as client device 102, and devices and servers located in the outside wide area network, such as server 124. Requests from devices in the local area network to devices and servers outside the local area network pass through the residential gateway 120.

In some embodiments, the ad resource ID 158 includes a reference to the server or computing device for an IPTV provider, such as provider device 130. The provider device 130 may be a server operated by the IPTV provider, a cluster of servers operated by the IPTV provider, a server operated by a third party under contract to the IPTV provider, a virtual instance running on a virtual machine, or any other combination of hardware and software. At circled number 3, based on the ad resource ID 158, client device 102 sends a request for the advertisement to provider device 130 based on the ad resource ID 158. When the provider device 130 receives the request for an advertisement from the client device 102, it will determine whether the request comes from an address that is associated with a subscriber account. In some embodiments, provider device 130 includes a subscriber database 132 that includes a database of subscriber accounts and the current addresses assigned to these subscriber accounts. Provider device 130 may consult this subscriber database 132 to determine whether the request for the advertisement is from a valid subscriber. In some embodiments, subscriber database 132 includes the wide area network internet addresses that have been assigned to the subscribers of the IPTV provider. By consulting this subscriber database 132, the provider device 130 may determine whether an address is one that has been assigned to a subscriber.

In some embodiments, a user may be using a proxy server or other intermediary such as VPN server or onion routing service to anonymize the user's communications when connecting to the wide area network. In such an instance, the provider device 130 may not be able to directly determine whether the request is associated with a subscriber account via the address of the request for ad 144 since the address has been changed by the intermediary service. In such a case, the provider device 130 may use additional methods to determine whether the request is from an address associated with a subscriber account. One method may include determining if the client device includes an identifier that was previously placed by the provider when the user of the client device visited a website or application associated with the provider. This identifier may be a cookie. Another method may include a special application installed on the client device that the user of the client device has agreed to install and which identifies the client device to the provider device 130 regardless of the address of the request 144. Yet another method may be to have the RG 120 modify the contents of the request message to include an indicator of the subscriber of the request.

At optional circled number 4a, provider device 130 has determined that the address that the request for advertisement 144 came from is from a valid subscriber. The provider device 130 may consult the residential gateway 120 associated with the subscriber account to request the address of the set top box 108 on the subscriber's local network. The provider device 130 sends a request for STB address 160 to the residential gateway 120. The residential gateway 120 includes a store 122 to store the addresses of client devices in the local network, including STB 108. At optional circled number 4b, the residential gateway 120 sends a response with the address of the STB to the provider device 130.

In some embodiments, once the provider device 130 determines that the request for ad 144 comes from a valid subscriber, the provider device 130 does not send a request to the residential gateway 120 and instead consults its subscriber database 132 to determine the local network address of the set top box (STB) associated with the subscriber account. In some embodiments, the address of the STB is provided to the provider device 130 by messages received by the provider device from the STB 108.

At circled number 4c, in some embodiments, provider device 130 has determined that the address that the request for ad 144 came from is from a valid subscriber. The provider device 130 sends a redirect message to the client device 102. The redirect message sent by the provider device 130 causes the client device 102 to redirect its original request for ad 144 to the STB 108 and send a request to the STB 108. In some embodiments, this redirect is a Hypertext Transfer Protocol (HTTP) Redirect (e.g., with HTTP status code 3xx). In some embodiments, this redirect is accomplished via a different network protocol supported by the application requesting the ad on the client device and supported by the provider device 130.

In some embodiments, if the provider device 130, via the subscriber database 132, determines that the request for ad 144 is not associated with a subscriber, the provider device 130 sends a redirect to the client device 102 for the ad server. This redirect will cause the client device 102 to request an advertisement from the ad server 136 for an advertisement. Since the client device 102 is not associated with a subscriber account, the request for the advertisement in this case does not also include an indicator of the currently playing program, and the ad server will respond to this request with an un-targeted ad that is not selected based on any currently playing media program.

At circled number 5, the redirect causes the client device 102 to send a request 148 to the STB 108 that may be currently playing a media program. At circled number 6, this request causes the STB to return a redirect 150 to the ad server 136 that includes an indicator 114 of the currently playing media program 118. This indicator may be included in the redirect 150 as a query string.

In some embodiments, the STB is coupled with a display 116. Display 116 may be any device that may output an audio, video, audiovisual, or media program, and may include a television, a smart television, a projection screen, a monitor, etc. STB 108 may be any device capable of receiving data from a server of an (IPTV) provider, and may be a combination of hardware and software. As used herein, the server of the provider may be the provider device 130 as illustrated, or may be another server used to send data to the STB 108. The data received by STB 108 includes various media programs and other data elements that may be needed to operate the IPTV system. The STB 108 may also communicate with the provider by sending data along an upstream path in the opposite direction from the data that is received at the STB. In some embodiments, the display 116 and the STB 108 are combined in a single device. In this single device, the STB 108 and the display 116 may operate as separate components, or the STB and the display may operate via a same set of components, or the STB and the display may operate by sharing at least some components.

In some embodiments, the redirect message 146 to STB at circled number 4c also includes a token. This token may be included in the redirect as a query string. When the redirect causes the client device 102 to redirect the request 148 to the STB 108 as illustrated at circled number 5, this token will also be sent to the STB. The token allows the client device to authenticate with the STB. In some embodiments, the STB only accepts and processes requests that include a token. In some embodiments, the STB 108 validates a token through token verification 112. In some embodiments, the token is not session specific. In some embodiments, all set top boxes associated with the particular provider in the system authenticate via the same token. In some embodiments, each STB has a unique token that it will accept and validate. In some embodiments, the token is a rotating hash.

In some embodiments, when the request 148 to the STB 108 as illustrated at circled number 5 includes a token that the STB 108 authenticates as valid, the request causes the STB 108 to send a response that is a redirect 150 to the advertisement server 136 including an indication of the currently playing media program at circled number 6.

In some embodiments, when the request 148 to the STB includes a token that the STB 108 is unable to validate, the request may cause the STB to instead return a redirect 150 that does not include an indicator of the currently playing media program. Instead, the redirect 150 may only redirect the client device 102 to request an un-targeted advertisement from ad server 136. In some embodiments, when the request 148 to the STB does not include a token but the STB 108 expects a token, the request may cause the STB to react in the same fashion as if it received a token which it cannot verify.

At circled number 6, as noted, the STB 108 responds to request 148 with a redirect 150 to ad server 136 that includes an indicator 114 of the currently playing media program. This indicator may be included in redirect 150 as a query string. In some embodiments, redirect 150 is an HTTP Redirect response that includes the address of the ad server and a query string including the indicator of the currently playing program. In some embodiments, redirect 150 redirects client device 102 to the ad server 136 using a custom protocol designed for an application running on client device 102.

At circled number 7, client device 102 sends a request 152 to ad server 136 based on the redirect 150 in circled number 6. In some embodiments, this request 152 includes the indicator 114 of the currently playing program. This indicator may be included in request 152 as a query string. When ad server 136 receives the request 152, it will respond with response 154 that includes the advertisement at circled number 8. In embodiments where the request 152 includes an indicator of the currently playing program, that indicator causes the ad server 136 to select a targeted advertisement based on a database of advertisements that have been selected for particular media programs. In some embodiments, this database is program-personal ad database 138. In some embodiments, the indicator is a unique identifier for the media program but does not allow the program to be identified. In some embodiments, the indicator identifies the media program. In some embodiments, the indicator 114 identifies the particular episode or time in the media program that is currently being played. In some embodiments, the indicator 114 further includes data identifying various viewing habits for the users who have used the STB 108. This data within the indicator may cause the ad server 136 to consult its advertisement database in order to respond with an advertisement that is selected based on the data present in the indicator.

For example, if the ad server 136 receives a request for an advertisement that includes a media indicator 114, it may query program-personal ad database 138 using the indicator to retrieve a particular advertisement that is targeted to the media program, episode, and/or viewing habits indicated by the indicator. This advertisement, which may be an image, text, or other media element, is then sent to client device 102. Thus, the advertisement that is selected is targeted to the currently playing media program or correlated with the currently playing media program.

In some embodiments, the set top box returns upon request not just an indicator of the currently playing media program, but an indicator including a history of one or more media programs that have been played on the system. This may allow the system to produce a targeted advertisement based upon a previously played media program or based upon a combination of the previously played media programs.

If no indicator is provided to the ad server 136, the ad server may respond with an advertisement that is not targeted towards any media program. This advertisement may be selected based on a priority list stored in ad server 136, or based on the geo-located address of the request, or other factors.

In some embodiments, ad server 136 is a separate hardware device. In some embodiments, ad server 136 and provider device 130 both reside on a server device 164, which may be owned and/or managed by the IPTV provider. The ad server 136 and the provider device 130 may be virtual devices residing on the hardware of the server device 164, or may both be hardware devices that may share some, all, or no components in common.

At circled number 8, ad server 136 sends response 154 with the advertisement to the client device 102. This advertisement may be customized to the currently playing media program as described above. Once the client device 102 receives the advertisement, it is displayed as advertisement 106 on the client device 106. In some embodiments, ad 106 is displayed in a web page 104 on the client device 102. In some embodiments, ad 106 is displayed in an application on client device 102.

In some embodiments, a local network or a home or a subscriber account may have multiple associated client devices or multiple associated set top boxes. Furthermore, more than one of these devices or set top boxes may be on at the same time, with each set top box playing a different media program. In such a case, the system must determine which user using which client device may be watching which program on which set top box. In some embodiments, to deliver the correct targeted advertisement to each user's client device, the system may ask the user via the client device which set top box he or she is using. In some embodiments, the system, possibly through the residential gateway 120, determines where each set top box is based on an initial set up procedure where a user is asked to specify where each set top box is. Based on this information, if the system uses a wireless network, the residential gateway may further be able to determine which set top box the user of a client device is interacting with based on the direction and signal strength of the client device on the wireless network. In some embodiments, the system may monitor traffic from the client device, possibly after consent of the user of the client device, and based on the content of the traffic may be able to determine which set top box the user is interacting with. For example, if a set top box is playing a particular program related to vampires, and a user is making searches for this program, the system may determine that there is a high likelihood that user is consuming the program from that particular set top box, and will deliver advertisements targeted to that vampire show to that user's client device.

In some embodiments, the determination uses a priority list. The system consults the priority list to determine which set top box to request a media program indicator from first, and uses a priority list to determine which client device or client devices to deliver the targeted advertisement to.

In some embodiments, the client device is behind a firewall. This may be a hardware and/or software firewall. In some circumstances, the redirect messages, such as redirect 146, when received by the firewall, cause the firewall to reject these messages as harmful. As a result, the client device might not be transmitted an advertisement at all. To resolve this issue, the system may be able to determine that the client device never made a further request after receiving the redirect message, and in response to such an error condition, may simply send a generic advertisement without a redirect when the same client device requests another advertisement. In some embodiments, the system forwards the messages to the residential gateway, and causes the residential gateway to send the redirect message to the client device. In this way, the firewall connected to the client device may determine that the redirect is from a local network source, and poses no danger, and may allow it instead.

In some embodiments, once the system receives a request for an advertisement from the client, and later causes an advertisement to be transmitted to the client, the client may in the future display the cached copy of the transmitted advertisement instead of requesting a new advertisement. To prevent this, the system may transmit the advertisement along with an expiration indicator to indicate to the client when the advertisement is “stale” and no longer current. By setting this expire indicator, the client requests a new advertisement every time instead of using a cached copy.

Note that the server 124 does not need to be owned by the IPTV provider. Instead, in some embodiments, the provider purchases advertisements with the website, service, or advertising network, etc., associated with the website or other service provided by server 124. The provider provides a resource identifier for the advertisement, such as ad resource ID 158, to the entity that manages the advertisements for server 124. This identifier is then passed to the user to display the targeted advertisement as described above.

Note that while the above embodiments were described in relation to an IPTV network, the system as described may be implemented on any type of media distribution system that is able to have the properties described above. For example, the above embodiments could be implemented in a traditional cable or satellite broadcast network so long as the system is able to communicate the currently playing media program from a STB to an ad server.

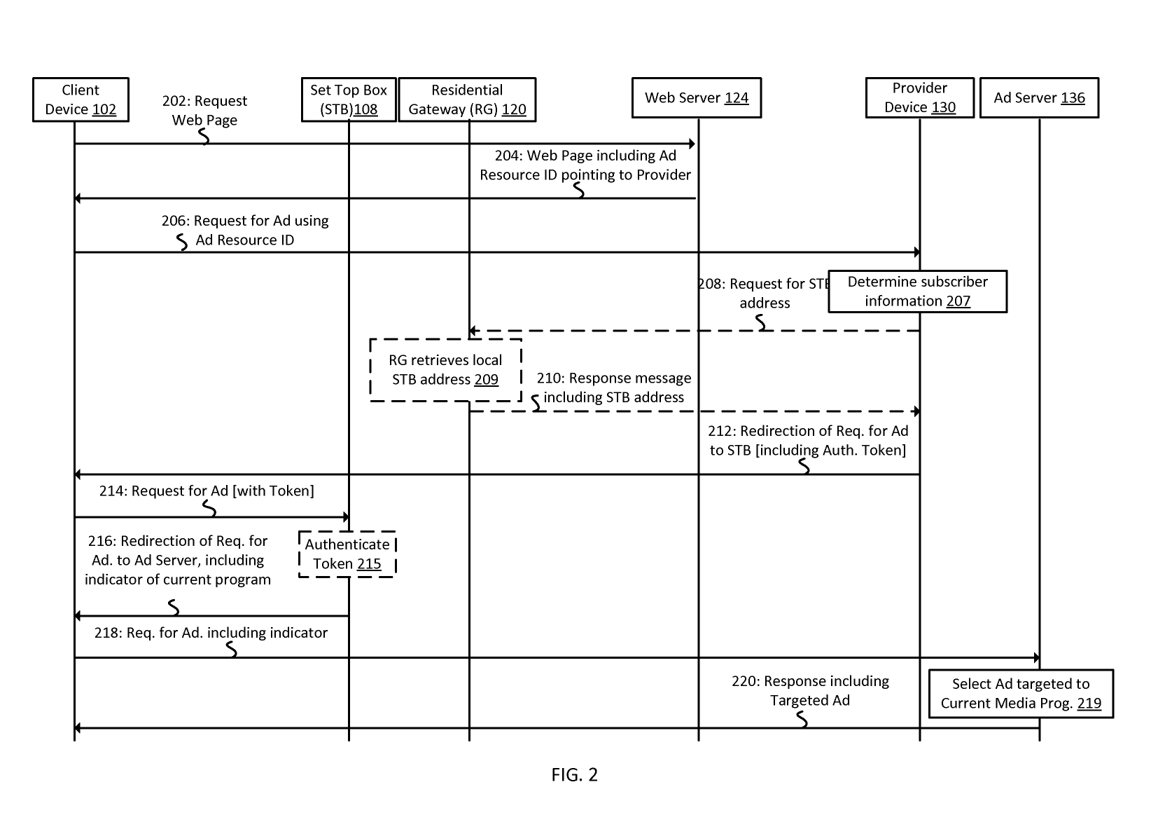

FIG. 2 is a network transaction diagram illustrating an exemplary set of operations for context-sensitive advertising according to one embodiment. The network devices illustrated in FIG. 2 include client device 102, STB 108, residential gateway (RG) 120, web server 124, provider device 130, and ad server 136.

At 202, the client device transmits a request message 202 to web server 124. In some embodiments, request 202 is an HTTP message requesting a resource such as a web page. At 204, web server 124 responds to request 202 with response 204 including the requested resource and an ad resource ID 158 that points to the provider device 130. In some embodiments ad resource ID 158 is a URL. At 206, the ad resource ID 158 causes client device 102 to send a request 206 for ad resource from the provider device 130.

At 207, provider device 207 receives the request 206 for an advertisement from the client device 102 including the ad resource ID 158. Upon receiving this request 206, at 207, provider device determines based on the request 206 whether the request is associated with an address of a subscriber account. If the request is associated with an address of a subscriber account, the provider device determines the address of the STB 108 associated with the subscriber account. In some embodiments, the provider device determines the address of the STB 108 by sending a request 208 to RG 120. In some embodiments, at 209, the RG 120 retrieves the local address of STB 108. This local address may be an address that is addressable only on the local network situated behind the RG 120. In some embodiments, at 210, RG 120 sends response 210 to provider 130 including the address of the STB 108. In some embodiments, provider 130 does not request the address of STB 108 from RG 120. Instead, provider 130 knows the address of STB 108 prior to the request 206. In some embodiments, provider 130 receives the address of STB 108 from RG 120 in an update message prior to request 206. In some embodiments, provider 130 receives the address of STB 108 from STB 108 as part of an update message.

At 212, the provider device responds to request 206 from client device 102 with a redirect message 212 to redirect the request 206 to STB 108. This redirect 212 causes client device 102 to send a request 214 to STB 108 for an advertisement. This request 214 causes STB to return a redirect message 216 redirecting the request from the client 102 to an advertisement server 136 including an indicator of the currently playing media program. In some embodiments, this indicator is media program indicator 114.

In some embodiments, redirect 212 includes an authentication token. This redirect with authentication token causes client device 102 to send request 214 for an ad to STB 108 and also pass the authentication token to STB 108. When the STB 108 receives the request 214 including the authentication token, the request 214 causes STB 108 to authenticate the token to determine whether the request is authentic. The methods by which the token may be formed and by which the STB 108 may verify the token are described above. If the STB 108 determines the token is authentic, it returns a redirect message 216 redirecting the request from the client 102 to an advertisement server including an indicator of the currently playing media program. In some embodiments, this indicator is media program indicator 114.

At 218, based on the redirect message 216, client device 102 sends a request message 218 including an indicator of the currently playing media program. At 219, the ad server 136 receives the request message 218 and the message causes ad server 136 to select an advertisement targeted towards the currently playing media program or correlated with the currently playing media program. In some embodiments, the advertisement is selected from a database that correlates advertisements with the indicator of the currently playing media program in request 218.

At 220, the ad server responds with the targeted advertisement in response message 220. Once the client device 102 receives the message, it may display the message on a display connected to the device 102.

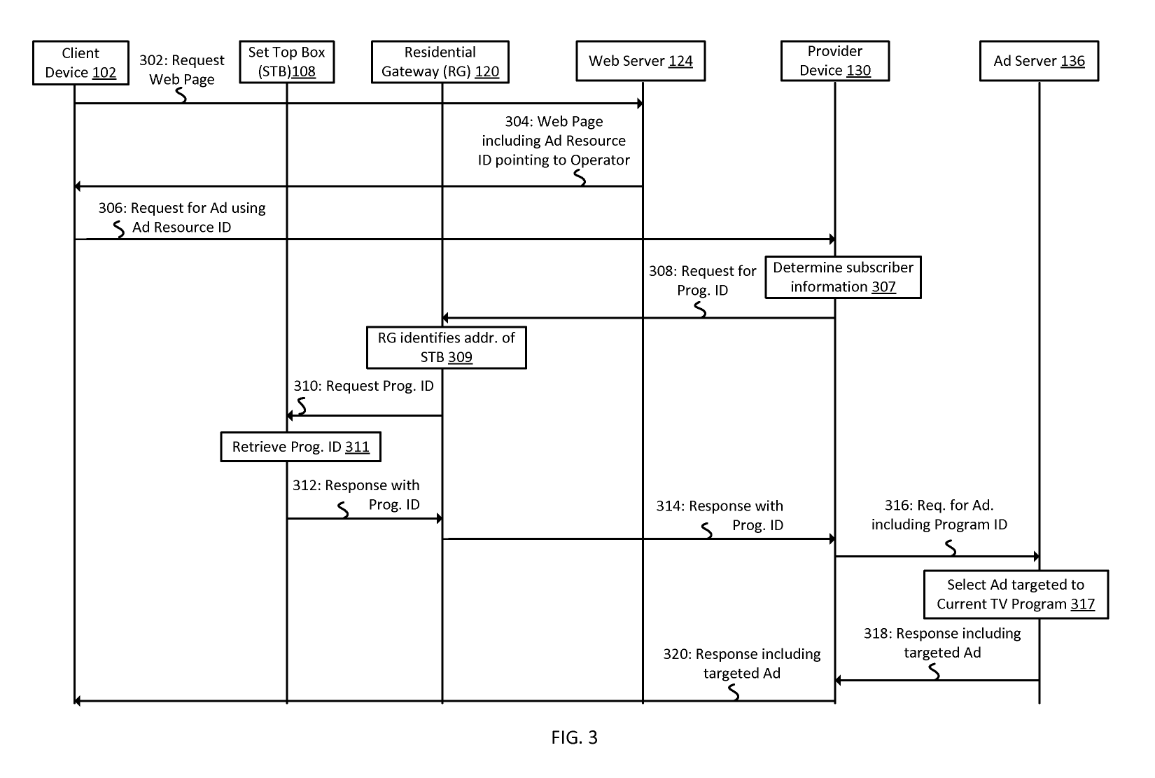

FIG. 3 is a network transaction diagram illustrating an exemplary set of operations for context-sensitive advertising according to another embodiment. While FIG. 2 illustrated an embodiment where the redirect from the provider device 130 causes the client device 102 to request an indicator of the currently playing media program from the STB 108; embodiments are not so limited and in other embodiments the provider device 130 causes the RG 120 to request an indicator of the currently playing media program from the STB 108. The network devices illustrated in FIG. 3 include client device 102, STB 108, residential gateway (RG) 120, web server 124, provider device 130, and ad server 136.

At 302, the client device transmits a request message 302 to web server 124. In some embodiments, request 302 is an HTTP message requesting a resource such as a web page. At 304, web server 124 responds to request 302 with response 304 including the requested resource and an ad resource ID 158 that points to the provider device 130. In some embodiments ad resource ID 158 is a URL.

At 306, the response 304 including the ad resource ID 158 causes client device 102 to send a request 306 for ad resource, which is received by provider device 130. At 307, provider device 130 determines the subscriber account information based on request 306. In some embodiments, provider device 130 determines the subscriber account information based upon the source address of the request 306 and a subscriber database that includes the addresses assigned to each subscriber account.

At 308, provider device 130 queries the RG associated with the subscriber account determined in 307 to make a request 308 for an identifier of the currently playing media program. At 309, request 308 causes RG 120 to identify the address of the STB 108 and send a request 310 to STB 108 to request the identifier of the currently playing program. In some embodiments, request 310 is a simple HTTP request. In some embodiments, request 310 is an encrypted message using a proprietary protocol between RG 120 and STB 108. In some embodiments, request 310 includes a token that STB 108 uses to authorize the request 310 before responding to it.

At 311, STB 108 retrieves the identifier of the currently playing media program. In some embodiments, this identifier is identifier 114. At 312, STB 108 responds to RG 120 with response 312 including the identifier of the currently playing media program. At 314, RG 120 sends a response 314 with this identifier of the currently playing media program to provider device 130. In some embodiments, the communications between provider device 130 and RG 120 are encrypted and may further use a proprietary communications protocol.

At 130, provider device 130 sends a request 316 to ad server 136 with the identifier of the currently playing media program. At 317, ad server 136 receives the request 316, and this request 316 causes ad server 136 to selected an ad targeted to the currently playing media program based on the identifier in the request 316.

At 318, the ad server 136, after selecting the targeted ad, responds to provider device 130 with the targeted ad with response 318. At 320, provider device sends a response 320 including the targeted ad received from ad server 136 to the client device 102. After the client device 102 receives the response 320 with the targeted ad, the client device 102 may display the targeted advertisement on a display device connected to the client device 102.

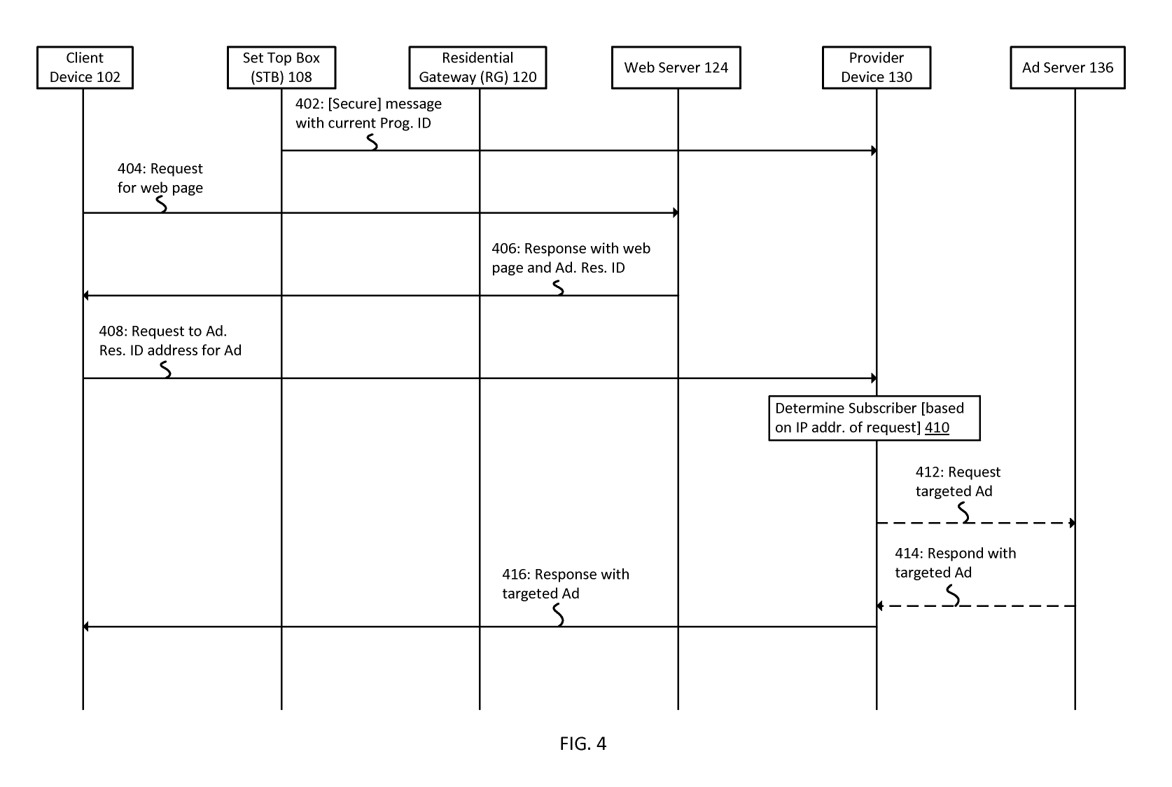

FIG. 4 is a network transaction diagram illustrating an exemplary set of operations for context-sensitive advertising according to another embodiment. While FIG. 2 illustrated an embodiment where the redirect from the provider device 130 causes the client device 102 to request an indicator of the currently playing media program from the STB 108; embodiments are not so limited and in other embodiments the provider device 130 receives from the STB 108 an indicator of the currently playing media program before the provider device 130 receives the request for an ad from the client device 102. The network devices illustrated in FIG. 4 include client device 102, STB 108, residential gateway (RG) 120, web server 124, provider device 130, and ad server 136.

At 402, the provider device 130 receives from set top box 108 a message 402 with an identifier of the currently playing media program. In some embodiments, provider device 130 receives message 402 from STB 108 when a new media program is selected to be played by STB 108. In some embodiments, STB 108 sends message 402 when it is initialized and a program is selected to be played by it. In some embodiments, STB 108 sends message 402 at regular intervals. In some embodiments, message 402 includes identifiers for a history of media programs played by STB 108. This history may include the media programs played since last initialization, or the media programs played over a certain interval. In some embodiments message 402 further identifies other statistics and/or data regarding the media playing history of STB 108. In some embodiments, message 402 further identifies the account associated with the STB 108, and if there are multiple STBs associated with the account, the message 402 may also identify which STB sent it. In some embodiments, STB 108 sends a message to provider device 130 when it is turned off.

At 404, client 102 sends a request 404 for a web page or other data to web server 124. At 406, web server 124 responds to client 102 with response 406 including the ad resource ID pointing to the provider device 130. In some embodiments, request 404 is an HTTP request. In some embodiments the ad resource ID is a URL. In some embodiments, request 404 is made after an arbitrary period of time after provider device 130 receives message 402 from STB 108.

At 408, client device 108 sends a request 408 for an ad based on the ad resource ID in response 406, and provider device 130 receives request 408 for the ad from client device 102. At 410, provider device 130 determines the subscriber account associated with the request 408. In some embodiments, provider device 130 determines the subscriber account information based upon the source address of the request 408 and a subscriber database that includes the addresses assigned to each subscriber account. Provider device 130 then determines the currently playing media program based upon message 402 sent to it by STB 108. In some embodiments, provider device 130 looks up the associated STB and the message 402 sent by the STB and retrieves the identifier of the currently playing program from that message. If the account is associated with more than one STB, provider device 130 may further determine which STB is currently playing a program and use the message sent from that STB. Provider device 130 may also distinguish between different STBs associated with the same account based on the methods described above.

At 412, provider device 130, in some embodiments, requests a targeted ad based on the currently playing program from ad server 136. At 414, in some embodiments, provider device 130 receives from ad server 136 the targeted ad. In some embodiments, a single hardware and software device may comprise the functionality of both the provider device 130 and ad server 136, and thus the provider device 130 does not need to make a separate request to an ad server for a targeted ad and may instead retrieve the targeted ad that is based upon the currently playing program from a database present in the single combined device itself.

At 416, provider device 130 sends response 416 including the targeted ad to client device 102. This response 416 may cause the client device 102 to display the targeted ad on a display connected to client device 102.

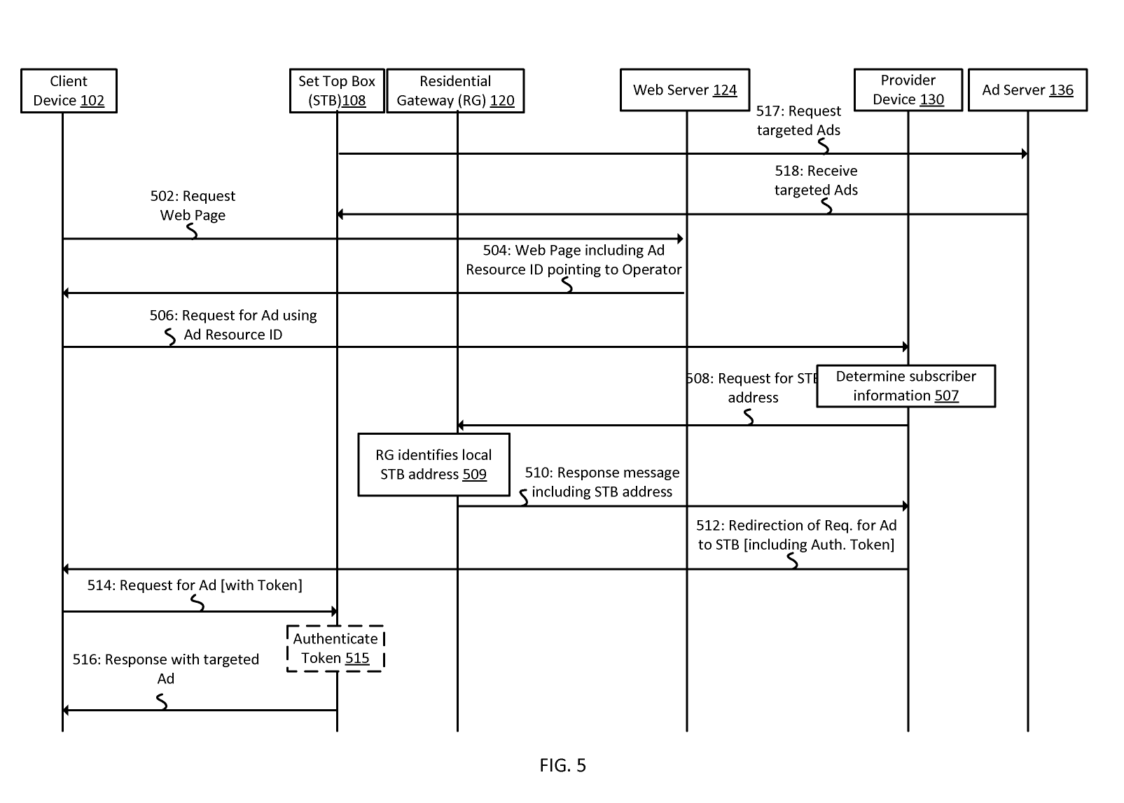

FIG. 5 is a network transaction diagram illustrating an exemplary set of operations for context-sensitive advertising according to one embodiment. While FIG. 2 illustrated an embodiment where a message from the provider device 130 causes the client device 102 to request an ad from the ad server 136; embodiments are not so limited and in other embodiments the client device 102 requests and receives the ad directly from the STB 108. The network devices illustrated in FIG. 5 include client device 102, STB 108, residential gateway (RG) 120, web server 124, provider device 130, and ad server 136.

At 517, STB 108 sends a request 517 for a set of one or more targeted ads. In some embodiments, these targeted ads correlate with various media programs that may be played by the STB 108. In some embodiments, the storage space in the STB 108 for targeted ads is limited. In such a case, the STB 108 may request targeted ads corresponding to some of the media programs which are most frequently selected by a user to be played by the STB 108. At 518, the ad server 136 returns the selected list of targeted ads.

At 502, the client device 102 requests a web page or other data from the web server 124. At 504, web server 124 responds to client 102 with response 504 including the ad resource ID pointing to the provider device 130. In some embodiments, request 502 is an HTTP request. In some embodiments the ad resource ID is a URL. In some embodiments, request 502 is made after an arbitrary period of time after provider device 130 receives message 517 from STB 108.

At 506, client device 108 sends a request 506 for an ad based on the ad resource ID in response 504, and provider device 130 receives request 506 for the ad from client device 102. At 507, provider device 130 determines the subscriber account associated with the request 506. In some embodiments, provider device 130 determines the subscriber account information based upon the source address of the request 506 and a subscriber database that includes the addresses assigned to each subscriber account.

At 508, provider device 130, in some embodiments, after determining the subscriber account associated with the request 506, sends a request to RG 120 associated with the subscriber account to request the address of the STB. At 509, the message 508 causes RG 120 to determine the address of the STB 108. In some embodiments, RG 120 stores the addresses of local devices on the local network, and RG 120 knows the address of the STB 108. In some embodiments, more than one STB is associated with the subscriber account. In such a case, the RG may determine which STB is the correct STB based on the methods described above.

At 510, the request 508 from provider device 130 causes RG 120 to send response 110 including the address of STB 108. In some embodiments, the address of STB 108 is an IP address on the local network of the RG 120 or the subscriber. In some embodiments, the address of the STB 108 is a domain name that may be resolved within the local network administered by the RG 120 to the STB. In some embodiments, provider device 130 does not need to query the RG 120 for the local address of the STB 108, and knows it already based on records in a data store.

At 512, the provider device 130 sends a redirect message 512 to client device 102 with a redirect for the ad to the address of the STB 108. This is the address that provider device 130 received in message 510. In some embodiments, message 512 also includes a token that allows the client device to authenticate with STB 108, according to the methods described above.

At 514, in response to the redirect message 512, client device sends request 514 to STB 108 for the ad. In some embodiments, this request includes the token passed from the provider device in message 512. At 515, in some embodiments, STB 108 authenticates the token and processes the request 515 for an ad.

At 516, the STB 108 responds with the request 514 for an ad with an ad targeted to the currently playing media program. The STB 108 knows of the currently playing media program as the media program is being played by the STB 108. The targeted ad for the playing media program has been cached by the STB 108 via request 517 and response 518, and so the STB will pick the ad from its cache which correlates to the currently playing media program, and send this ad in response 516. In some embodiments, the STB has a limited cache of targeted ads, and does not have cached the targeted ad for the currently playing media program. In this case, instead of requesting the correct targeted ad from a media server, the STB 108 may instead return a generic advertisement which is not targeted to the currently playing media program.

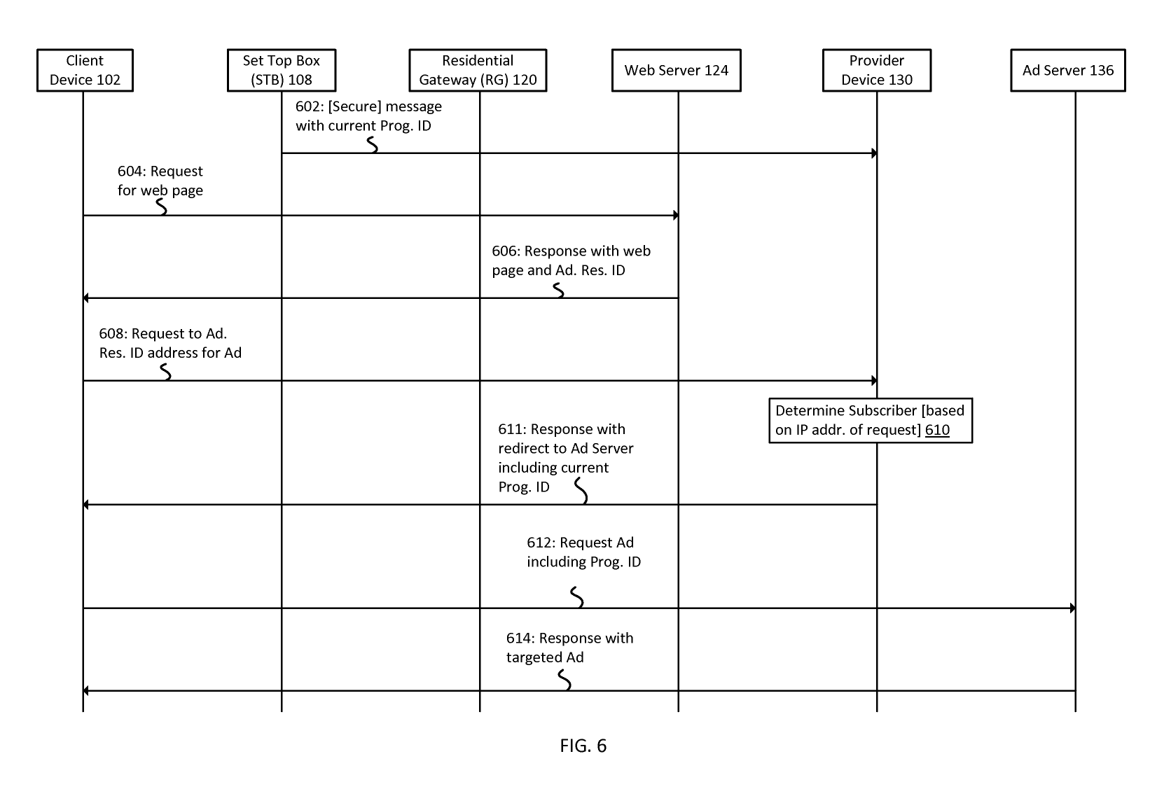

FIG. 6 is a network transaction diagram illustrating an exemplary set of operations for context-sensitive advertising according to another embodiment. While FIG. 4 illustrated an embodiment where the provider device 130 forwards the request for an ad from the client device 102 to the ad server 136; embodiments are not so limited and in other embodiments the redirect message from the provider device 130 causes the client device 102 to request the ad directly from the ad server 136. The network devices illustrated in FIG. 6 include client device 102, STB 108, residential gateway (RG) 120, web server 124, provider device 130, and ad server 136.

At 602, the provider device 130 receives from set top box 108 a message 602 to with an identifier of the currently playing media program. In some embodiments, provider device 130 receives message 602 from STB 108 when a new media program is selected to be played by STB 108. In some embodiments, STB 108 sends message 602 when it is initialized and a program is selected to be played by it. In some embodiments, STB 108 sends message 602 at regular intervals. In some embodiments, message 602 includes identifiers for a history of media programs played by STB 108. This history may include the media programs played since last initialization, or the media programs played over a certain interval. In some embodiments message 602 further identifies other statistics and/or data regarding the media playing history of the STB 108. In some embodiments, message 602 further identifies the account associated with the STB 108, and if there are multiple STBs associated with the account, the message 602 may also identify which STB sent it. In some embodiments, STB 108 sends a message to provider device 130 when it is turned off.

At 604, client 102 sends a request 604 for a web page or other data to web server 124. At 606, web server 124 responds to client 102 with response 606 including the ad resource ID pointing to the provider device 130. In some embodiments, request 604 is an HTTP request. In some embodiments the ad resource ID is a URL. In some embodiments, request 604 is made after an arbitrary period of time after provider device 130 receives message 602 from STB 108.

At 608, client device 108 sends a request 608 for an ad based on the ad resource ID in response 606, and provider device 130 receives request 608 for the ad from client device 102. At 610, provider device 130 determines the subscriber account associated with the request 608. In some embodiments, provider device 130 determines the subscriber account information based upon the source address of the request 608 and a subscriber database that includes the addresses assigned to each subscriber account. Provider device 130 then determines the currently playing media program based upon message 602 sent to it by STB 108. In some embodiments, provider device 130 looks up the associated STB and the message 602 sent by the STB and retrieves the identifier of the currently playing program from that message. If the account is associated with more than one STB, provider device 130 may further determine which STB is currently playing a program and use the message sent from that STB. Provider device 130 may also distinguish between different STBs associated with the same account based on the methods described above.

At 611, provider device 130 responds to request 608 with response message 616 including an identifier of the currently playing media program and a redirect to ad server 136. At 612, client device 102 sends request 612 for an ad including the identifier of the currently playing program in response to message 611. At 614, request 612 causes ad server 136 to respond with a targeted advertisement. In some embodiments, ad server 136 includes a database correlating advertisements with media programs, and selects a targeted advertisement from this database for response 614 based on the indicator of the currently playing program. Response 614, when received by client device 102, may cause client device 102 to display the targeted advertisement in response 614 on a display connected to client device 102.

Although FIGS. 1-6 describe embodiments where a targeted advertisement is selected and displayed on a client device based on a media program played by another client device such as a set top box, it should be understood that the client device playing the media program may not be a set top box but can be other types of client devices that play media programs (e.g., laptop computer, desktop computer, mobile phone, tablet device, e-reader device, head mounted display, wearable device, internet connected television, etc.).

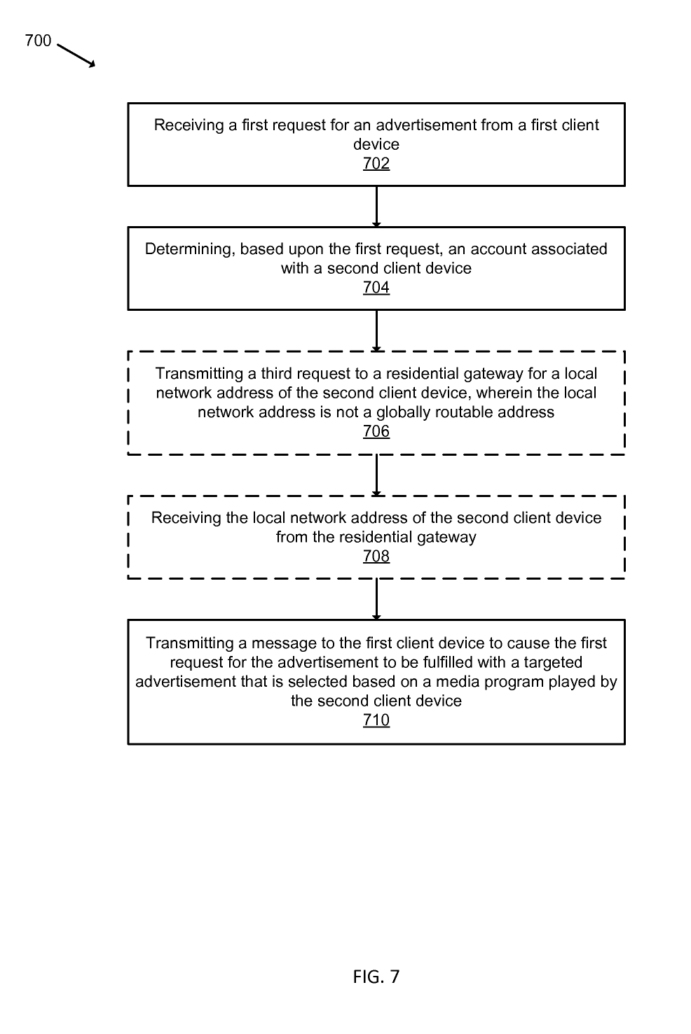

FIG. 7 is a flow diagram illustrating a method 700 in a server device for context-sensitive advertising according to an embodiment of the invention. In some embodiments, this method is performed by provider device 130. At 702, the method includes receiving a first request for an advertisement from a first client device (e.g., client device 102). At 704, the method includes determining, based upon the first request, an account associated with a second client device. In some embodiments, the account is a subscriber account. In some embodiments, the second client device is a set top box such as set top box 108, while in other embodiments the second client device is a laptop computer, desktop computer, mobile phone, tablet device, e-reader device, head mounted display, wearable device, internet connected television, or other device that may currently be playing a media program. In some embodiments, the advertisement is an advertisement identified by an ad resource ID 158.

In some embodiments, at 706, the method includes transmitting a third request to a residential gateway for a local network address of the second client device, wherein the local network address is not a globally routable address. In some embodiments, at 708, the method includes receiving the local network address of the second client device from the residential gateway. In some embodiments, the residential gateway is RG 120.

At 710, the method includes transmitting a message to the first client device to cause the first request for the advertisement to be fulfilled with a targeted advertisement that is selected based on a media program played by the second client device.

In some embodiments, block 710 includes transmitting a redirect message to the first client device to cause the first client device to transmit a second request for the advertisement. In some embodiments, the second request for the advertisement is transmitted to the second client device.

In some embodiments, the client device, responsive to a response message received from the second client device including an indicator of the media program played by the second client device, transmits a third request to an advertisement server for the advertisement that includes the indicator of the media program played by the second client device. In some embodiments, the indicator of the media program played by the second client device is media program indicator 114. In some embodiments, the advertising server is ad server 136.

In some embodiments, the redirect message is transmitted to an advertisement server. In some embodiments, the redirect message includes an indicator of the media program played by the second client device.

In some embodiments, block 710 includes transmitting the targeted advertisement to the first client device. In some embodiments, the server device on which method 700 is performed comprises the advertisement server.

Although the flow diagrams in the figures show a particular order of operations performed by certain embodiments of the invention, it should be understood that such order is exemplary (e.g., alternative embodiments may perform the operations in a different order, combine certain operations, overlap certain operations, etc.).

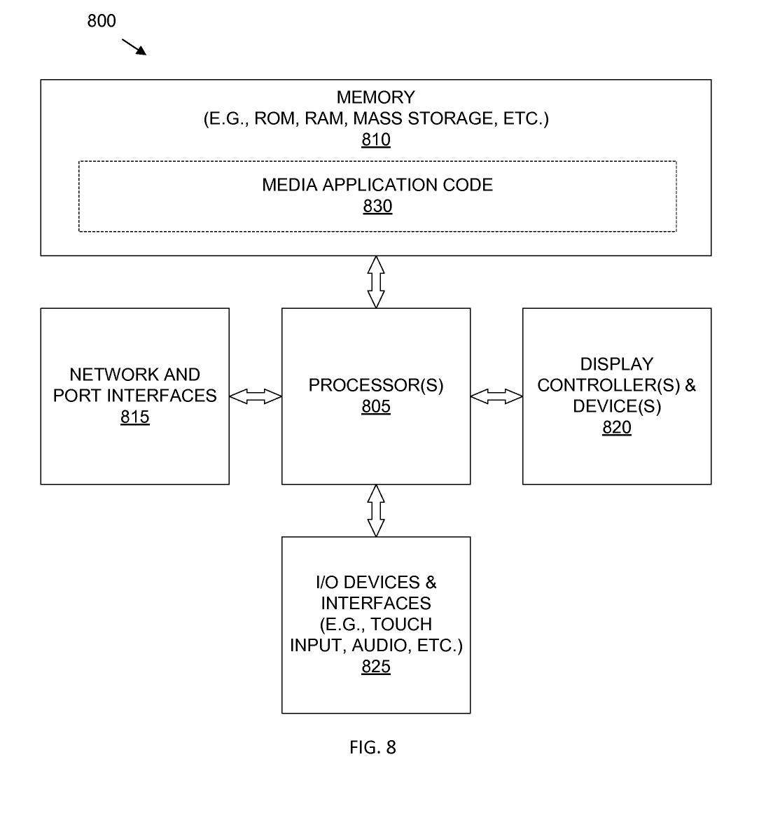

FIG. 8 illustrates a block diagram for an exemplary data processing system 800 that may be used in some embodiments. Data processing system 800 includes one or more microprocessors 805 and connected system components (e.g., multiple connected chips). Alternatively, the data processing system 800 is a system on a chip. One or more such data processing systems 800 may be utilized to implement the functionality of the client devices 102 and 108, server computing devices 130, and/or content servers 124 and 136, as illustrated in FIG. 1.

The data processing system 800 includes memory 810, which is coupled to the microprocessor(s) 805. The memory 810 may be used for storing data, metadata, and programs for execution by the microprocessor(s) 805. For example, the depicted memory 810 may store media application code 830 that, when executed by the microprocessor(s) 805, causes the data processing system 800 to perform the operations described herein. The memory 810 may include one or more of volatile and non-volatile memories, such as Random Access Memory (“RAM”), Read Only Memory (“ROM”), a solid state disk (“SSD”), Flash, Phase Change Memory (“PCM”), magnetic storage, or other types of data storage. The memory 810 may be internal or distributed memory. In some embodiments, a portion or all of the media application code 830 is stored on an external cloud device.

The data processing system 800 may also include a display controller and display device 820 that provides a visual user interface for the user, e.g., GUI elements or windows. The display device 820 may also display various media content to the user. The data processing system 800 also includes one or more input or output (“I/O”) devices and interfaces 825, which are provided to allow a user to provide input to, receive output from, and otherwise transfer data to and from the system. These I/O devices 825 may include a mouse, keypad, keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 800. The I/O devices and interfaces 825 may also include a connector for a dock or a connector for a USB interface, FireWire, Thunderbolt, Ethernet, etc., to connect the system 800 with another device, external component, or a network. Exemplary I/O devices and interfaces 825 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 800 with another device, external component, or a network and receive stored instructions, data, tokens, etc. In some embodiments, these various components will be provided as a system on a chip (SoC). It will be appreciated that one or more buses may be used to interconnect the various components shown in FIG. 8.

For example, the data processing system 800 may be a personal computer (PC), tablet-style device, a personal digital assistant (PDA), a cellular telephone (e.g., smartphone), a Wi-Fi based telephone, a handheld computer which may optionally include a cellular telephone, a media player, an entertainment system, a handheld gaming system, a wearable computing device (e.g., smartwatch, digital eyewear), or devices which combine aspects or functions of these devices, such as a media player combined with a PDA and a cellular telephone in one device. In other embodiments, the data processing system 800 may be a network computer, server, or an embedded processing device within another device or consumer electronic product. As used herein, the terms computer, system, device, processing device, and “apparatus comprising a processing device” may be used interchangeably with the term data processing system 800 and include the above-listed exemplary embodiments.

It will be appreciated that additional components, not shown, may also be part of the system 800, and, in certain embodiments, fewer components than that shown in FIG. 8 may also be used in a data processing system 800. For example, in some embodiments where the data processing system 800 is a set top box, the set top box may include components such as a digital broadcast receiver (e.g., satellite dish receiver, radio frequency (RF) receiver, microwave receiver, multicast listener, etc.) and/or a tuner that tunes to appropriate frequencies or addresses of received content. For example, a tuner may be configured to receive digital broadcast data in a particularized format, such as MPEG-encoded digital video and audio data, as well as digital data in many different forms, including software programs and programming information in the form of data files. As another example, the set top box may include a key listener unit to receive authorization and/or session keys transmitted from a server. The keys received by listener unit may be used by cryptographic security services implemented in a protection mechanism in the set top box to enable decryption of the session keys and data.

The set top box may further include components such as an encryption and/or decryption integrated circuit to decrypt incoming signals from the network and encrypt outgoing media signals to a display device. The digital set top box may also include a receptacle to receive an encryption key store that includes the encryption keys used to decrypt incoming signals. The set top box may further include a Wi-Fi, Bluetooth, infrared, or other input method to receive input from a controller device such as a keyboard, a remote, a mobile application on a smartphone, etc.

It will be apparent from this description that aspects of the inventions may be embodied, at least in part, in software. That is, the computer-implemented methods may be carried out in a computer system or other data processing system in response to its processor or processing system executing sequences of instructions contained in a memory, such as memory 810 or other non-transitory machine-readable storage medium. The software may further be transmitted or received over a network (not shown) via a network and/or port interface 815. In various embodiments, hardwired circuitry may be used in combination with the software instructions to implement the present embodiments. Thus, the techniques are not limited to any specific combination of hardware circuitry and software, or to any particular source for the instructions executed by the data processing system 800.

An electronic device, such as the client devices, server computing devices, and/or content servers described herein, stores and transmits (internally and/or with other electronic devices over a network) code (which is composed of software instructions and which is sometimes referred to as computer program code) and/or data using machine-readable media, such as non-transitory machine-readable media (e.g., machine-readable storage media such as magnetic disks, optical disks, read only memory, flash memory devices, phase change memory) and transitory machine-readable transmission media (e.g., electrical, optical, acoustical or other form of propagated signals—such as carrier waves, infrared signals). Thus, an electronic device (e.g., a computer) includes hardware and software, such as a set of one or more processors coupled to one or more non-transitory machine-readable storage media (to store code for execution on the set of processors and data) and a set or one or more physical network interface(s) to establish network connections (to transmit code and/or data using propagating signals). One or more parts of an embodiment of the invention may be implemented using different combinations of software, firmware, and/or hardware.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in a server device, comprising:
receiving a first request for an advertisement from a first client device;
determining, based upon the first request, an account associated with a second client device; and
transmitting a message to the first client device to cause the first request for the advertisement to be fulfilled with a targeted advertisement that is selected based on a media program played by the second client device.

2. The method of claim 1, wherein transmitting the message to the first client device to cause the first request for the advertisement to be fulfilled includes transmitting a redirect message to the first client device to cause the first client device to transmit a second request for the advertisement.

3. The method of claim 2, wherein the second request for the advertisement is transmitted to the second client device.

4. The method of claim 2, further comprising:
prior to the transmitting the message to the first client device,
transmitting a third request to a residential gateway for a local network address of the second client device, wherein the local network address is not a globally routable address, and
receiving the local network address of the second client device from the residential gateway.

5. The method of claim 2, wherein the client device, responsive to a response message received from the second client device including an indicator of the media program played by the second client device, transmits a third request to an advertisement server for the advertisement that includes the indicator of the media program played by the second client device.

6. The method of claim 5, wherein the server device comprises the advertisement server.

7. The method of claim 2, wherein the redirect message is transmitted to an advertisement server, and wherein the redirect message includes an indicator of the media program played by the second client device.

8. The method of claim 1, wherein transmitting the message to the first client device to fulfill the first request for the advertisement includes transmitting the targeted advertisement to the first client device.

9. The method of claim 8, further comprising:
determining the media program played by the second client device; and
selecting the targeted advertisement based upon the determined media program played by the second client device.

10. The method of claim 1, further comprising:
receiving, from the second client device, an indicator of the media program played by the second client device.

11. An apparatus, comprising:
a processor; and
a memory, said memory storing instructions executable by said processor whereby said apparatus is operative to:
receive a first request for an advertisement from a first client device;
determine, based upon the first request, an account associated with a second client device; and
transmit a message to the first client device to cause the first request for the advertisement to be fulfilled with a targeted advertisement that is selected based on a media program played by the second client device.

12. The apparatus of claim 11, wherein the transmission of the message to the first client device to cause the first request for the advertisement to be fulfilled includes a transmission of a redirect message to the first client device to cause the first client device to transmit a second request for the advertisement.

13. The apparatus of claim 12, wherein the second request for the advertisement is transmitted to the second client device.

14. The apparatus of claim 12, further comprising:
prior to the transmission of the message to the first client device,
transmit a third request to a residential gateway for a local network address of the second client device, wherein the local network address is not a globally routable address, and
receive the local network address of the second client device from the residential gateway.

15. The apparatus of claim 12, wherein the client device, responsive to a response message received from the second client device including an indicator of the media program played by the second client device, is operative to transmit a third request to an advertisement server for the advertisement that includes the indicator of the media program played by the second client device.

16. The apparatus of claim 15, wherein the server device comprises the advertisement server.

17. The apparatus of claim 12, wherein the redirect message is transmitted to an advertisement server, and wherein the redirect message includes an indicator of the media program played by the second client device.

18. The apparatus of claim 11, wherein the transmission of the message to the first client device to fulfill the first request for the advertisement includes a transmission of the targeted advertisement to the first client device.

19. The apparatus of claim 18, wherein the apparatus is further operative to:
determine the media program played by the second client device; and
select the targeted advertisement based upon the determined media program played by the second client device.

20. The apparatus of claim 11, wherein the apparatus is further operative to:
receive, from the second client device, an indicator of the media program played by the second client device.

21. A system, comprising:
a server device, comprising a first processor and a first memory, said first memory storing a first set of instructions executable by said first processor whereby said server device:
receives a first request for an advertisement from a first client device;
determines, based upon the first request, an account associated with a second client device; and
transmits a redirect message to the first client device to cause the first client device to transmit a second request for the advertisement, wherein the second request for the advertisement is transmitted to the second client device;
a second client device, comprising a second processor and a second memory, said second memory storing a second set of instructions executable by said second processor whereby said second client device:
responsive to the receipt of the second request for the advertisement from the first client device, transmits a second redirect message, including an indicator of the media program being played by the second client device, to the first client device, to cause the first client device to transmit a third request for the advertisement, including the indicator of the media program being played by the second client device, to an advertisement server, to cause the advertisement server to respond with an advertisement that is selected based on the indicator of the media program being played by the second client device.

22. The system of claim 21, wherein the server device, prior to the transmission of the message to the first client device, further
transmits a fourth request to a residential gateway for a local network address of the second client device, wherein the local network address is not a globally routable address, and
receives the local network address of the second client device from the residential gateway.
